(19) United States
(12) Patent Application Publication
(10) Pub. No.: US 2008/0080893 A1
(43) Pub. Date: Apr. 3, 2008

(54) OPEN-CLOSE APPARATUS AND IMAGE FORMING APPARATUS

(75) Inventors: Keita ASAHINA, Saitama-shi (JP); Naomasa Okimura, Saitama-shi (JP); Satoru Hori, Saitama-shi (JP); TaeSung Kim, Saitama-shi (JP)

Correspondence Address: SUGHRUE MION, PLLC, 2100 PENNSYLVANIA AVENUE, N.W., SUITE 800, WASHINGTON, DC, 20037, US

(73) Assignee: Fuji Xerox Co., Ltd., Tokyo (JP)

(21) Appl. No.: 11/865,803

(22) Filed: Oct. 2, 2007

(30) Foreign Application Priority Data
Oct. 3, 2006 (JP) 2006-271667

(51) Int. Cl. G03G 21/18

(52) U.S. Cl. 399/114

(57) ABSTRACT

An open-close apparatus includes: a first member movably provided with respect to an apparatus main body; a second member movable with respect to the first member, and movably provided with respect to the apparatus main body; and a limiting section, provided between the first and second members, that limits a moving speed of the first and second members.

### CROSS-REFERENCE TO RELATED APPLICATIONS

This application is based on and claims priority under 35 USC 119 from Japanese Patent Application No. 2006-271667 filed Oct. 3, 2006.

### BACKGROUND

1. Technical Field

The present invention relates to an open-close apparatus and an image forming apparatus.

2. Related Art

A technique used in an open-close apparatus or image forming apparatus using a member or unit movably provided with respect to an open-close apparatus main body or image forming apparatus main body is known.

### SUMMARY

According to an aspect of the invention, there is provided an open-close apparatus including: a first member movably provided with respect to an apparatus main body; a second member movable with respect to the first member, and movably provided with respect to the apparatus main body; and a limiting section, provided between the first and second members, that limits a moving speed of the first and second members.

### BRIEF DESCRIPTION OF THE DRAWINGS

Exemplary embodiments of the present invention will be described in detail based on the following figures, wherein:

FIG. 1 is a cross-sectional view schematically showing a structure of an image forming apparatus according to a first exemplary embodiment of the present invention;

FIG. 2 is a cross-sectional view showing an open-close cover used in the image forming apparatus according to the first exemplary embodiment of the present invention;

FIG. 3 is a cross-sectional view showing the open-close cover and a transfer unit used in the image forming apparatus according to the first exemplary embodiment of the present invention;

FIG. 4 is a cross-sectional view along a line AA in FIG. 3, showing the open-close cover used in the image forming apparatus according to the first exemplary embodiment of the present invention;

FIG. 5A is a cross-sectional view of the open-close cover and the transfer unit used in the image forming apparatus according to the first exemplary embodiment of the present invention, showing a state where the transfer unit has moved at a 15-degree angle from a position where the transfer unit is used for image formation;

FIG. 5B is a cross-sectional view of the open-close cover and the transfer unit used in the image forming apparatus according to the first exemplary embodiment of the present invention, showing a state where the transfer unit has rotated at a 90-degree angle from the position where the transfer unit is used for image formation;

FIG. 6 is a cross-sectional view schematically showing a structure of a pressing mechanism used in the image forming apparatus according to the first exemplary embodiment of the present invention;

FIG. 7 is an explanatory view of a limiting plate used in the image forming apparatus according to the first exemplary embodiment of the present invention;

FIG. 8 is a cross-sectional view showing the open-close cover used in the image forming apparatus according to a second exemplary embodiment of the present invention;

FIG. 9A is a cross-sectional view of the open-close cover and the transfer unit used in the image forming apparatus according to the second exemplary embodiment of the present invention, showing a state where the transfer unit has moved at a 60-degree angle from the position where the transfer unit is used for image formation;

FIG. 9B is a cross-sectional view of the open-close cover and the transfer unit used in the image forming apparatus according to the second exemplary embodiment of the present invention, showing a state where the transfer unit has rotated at a 90-degree angle from the position where the transfer unit is used for image formation;

FIG. 10 is a cross-sectional view schematically showing a structure of the image forming apparatus according to a third exemplary embodiment of the present invention;

FIG. 11 is a cross-sectional view schematically showing a structure of the image forming apparatus according to a fourth exemplary embodiment of the present invention; and

FIG. 12 is a cross-sectional view explaining an operation of the image forming apparatus according to the fourth exemplary embodiment of the present invention when a sheet tray is opened.

### DETAILED DESCRIPTION

Next, exemplary embodiments of the present invention will be described based on the drawings.

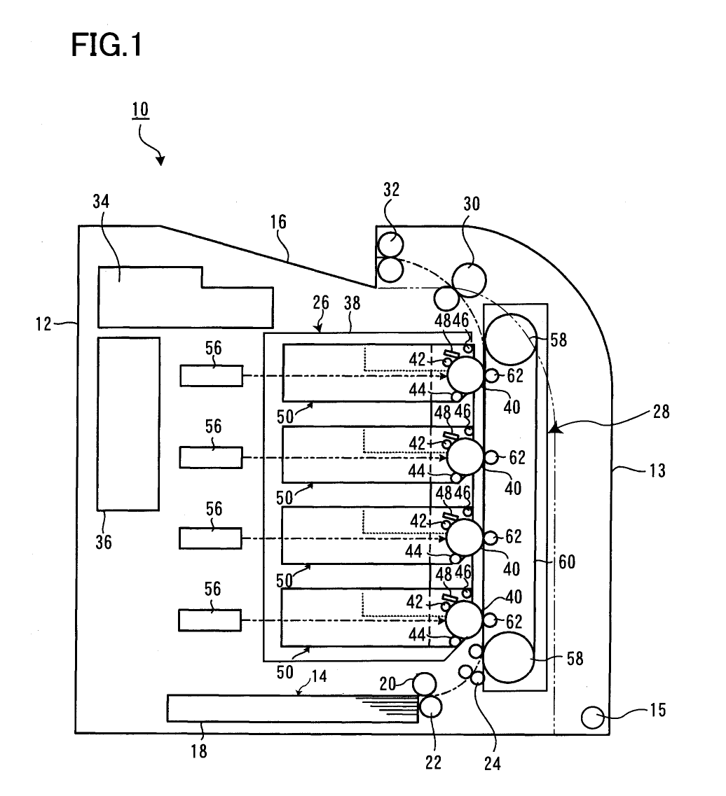

FIG. 1 shows an image forming apparatus 10 according to a first exemplary embodiment of the present invention. The image forming apparatus 10 has an image forming apparatus main body 12 used as an apparatus main body. A sheet feeding device 14 is provided in a lower part of the image forming apparatus main body 12, and a sheet discharge part 16 is formed in an upper part of the image forming apparatus main body 12.

The sheet feeding device 14 has a sheet tray 18 on which a large number of sheets are stacked. A feed roller 20 is provided at an upper end of the sheet tray 18 and a retard roller 22 is provided in a position opposite to the feed roller 20. A top sheet on the sheet tray 18 is picked up with the feed roller 20 and fed and conveyed by cooperation between the feed roller 20 and the retard roller 22.

The sheet conveyed from the sheet tray 18 is temporarily stopped with a registration roller 24, passed between a photoreceptor unit 26 and a transfer unit 28 to be described later and through a fixing device 30, at predetermined timing, and discharged with a sheet discharge roller 32 to the sheet discharge part 16.

A cover 13, used as a first member and used as an open-close cover, is provided on the front side of the image forming apparatus main body 12. The cover 13 is attached rotatably (movably) with respect to the image forming apparatus main body 12 with a shaft 15 used as a supporting section. The cover 13 rotate-moves with respect to the image forming apparatus main body 12.

The photoreceptor unit 26 used as a third member, the transfer unit 28 used as a second member and used as a unit, a power source unit 34 and a controller 36 are provided in the image forming apparatus main body 12. The photoreceptor unit 26, removably attached in the image forming apparatus main body 12, has a photoreceptor unit main body 38. In the photoreceptor unit main body 38, plural (e.g., four) sub units 50 are supported. The sub units 50 respectively have a photoreceptor 40. A charging device 42, having a charging roller to uniformly charge the photoreceptor 40, used as a charging section, a developing device 44 used as a developing section to develop a latent image written on the photoreceptor 40 with developing material (toner), a destaticizing device 46 used as a destaticizing section to emit light on the photoreceptor 40 after transfer thereby destaticize the photoreceptor 40, and a cleaning device 48 as a developing material removing section to remove developing material remaining on the photoreceptor 40 after transfer, are provided around the photoreceptor 40.

The four sub units 50, as a sub unit for forming a yellow toner image, a sub unit for forming a magenta toner image, a sub unit for forming a cyan toner image and a sub unit for forming a black toner image, from the upstream in a sheet conveyance direction as a gravitational downward direction, form a yellow toner image, a magenta toner image, a cyan toner image and a black toner image on the surfaces of the respective photoreceptors 40. The four sub units 50 are attachable/removable in the photoreceptor unit main body 38.

Optical writing devices 56, respectively having a laser exposure device, are provided in positions corresponding to the respective photoreceptors 40 on the rear surface side of the photoreceptor unit 26. The optical writing devices 56 form latent images by emitting laser to uniformly charged photoreceptors 40.

The transfer unit 28 is provided in a vertical direction opposite to the photoreceptor unit 26 on the front side of the photoreceptor unit 26. In the transfer unit 28, a conveyance belt 60 is put around two supporting rollers 58 provided in the vertical direction. Further, transfer rollers 62 are provided in a position opposite to the respective photoreceptors 40, with the conveyance belt 60 therebetween.

Accordingly, the respective photoreceptors 40 are uniformly charged with the charging devices 42, then latent images are formed with the optical writing devices 56 on the photoreceptors 40, and the latent images are visualized with the developing devices 44 using toner. The toner images formed on the respective photoreceptors 40 are transferred, sequentially from the lowest image, onto a sheet which is being conveyed, with the transfer rollers 62 in the transfer unit 28, and fixed with a fixing device 30 to the sheet.

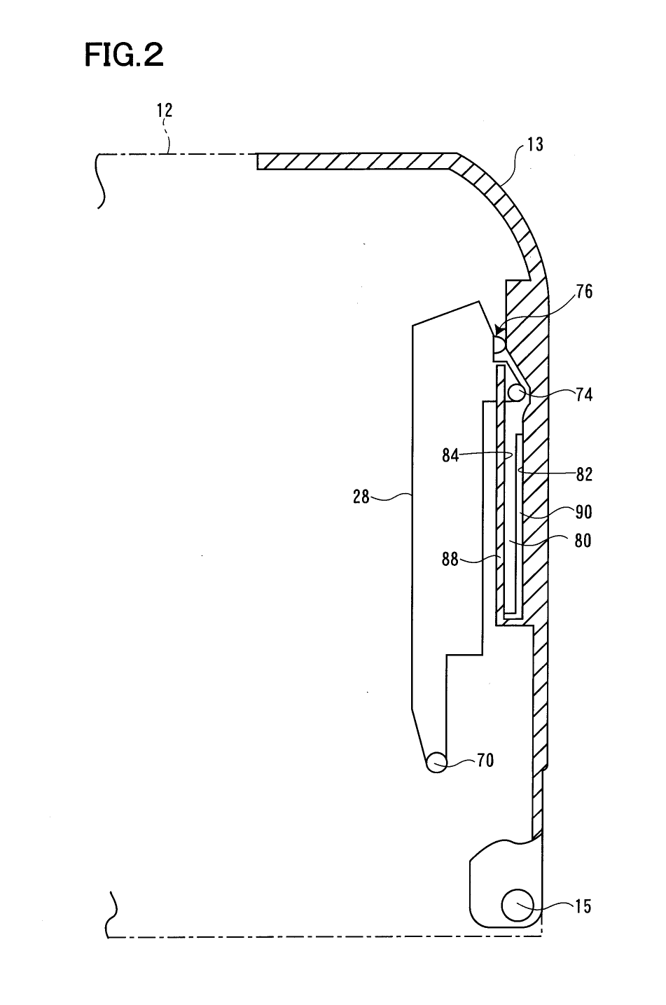

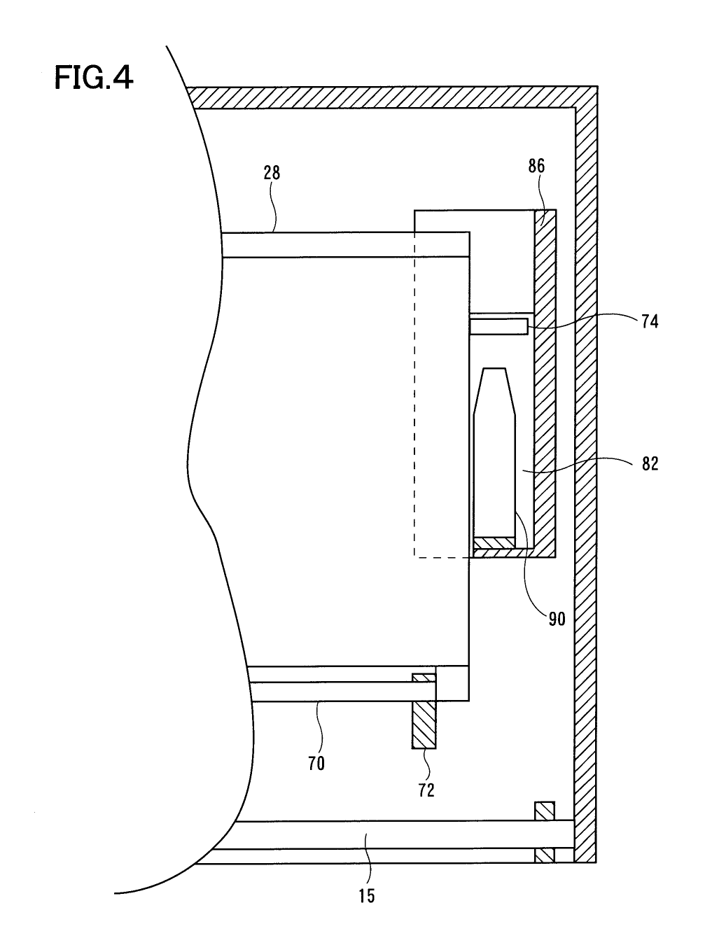

FIGS. 2 to 4 show the details of the transfer unit 28 and the cover 13. A shaft 70 is fixed to the lower end side of the transfer unit 28, and the shaft 70, provided on the image forming apparatus main body 12 side, is rotatably supported with a supporting member 72 formed of, e.g., a main body frame. Although FIG. 4 shows only the supporting member 72 to support the left end side of the shaft 70 in its lengthwise direction, the supporting member 72 is also provided on the right end side of the shaft 70. The shaft 70 is rotatably supported with the supporting members 72. Accordingly, the transfer unit 28 fixed to the shaft 70, rotates about the shift 70, thereby it is movable with respect to the image forming apparatus main body 12.

The transfer unit 28 rotates about the shaft 70, and moves with respect to the image forming apparatus main body 12. On the other hand, the cover 13 rotates about the shaft 15, and moves with respect to the image forming apparatus main body 12. Since the shaft 70 of the transfer unit 28 and the shaft 15 of the cover 13 are provided in different positions, when the cover 13 moves with respect to the image forming apparatus main body 12, the transfer unit 28 also moves with respect to the cover 13.

A projection 74 used as an engaged member is provided on the upper end side of the transfer unit 28. The projection 74, having an e.g. approximately cylindrical shape, is provided on the left side as shown in FIG. 4, and is also provided on the right side of the transfer unit 28.

A pressing mechanism 76 used as a pressing section is provided above the projection 74. The pressing mechanism 76 is provided in right and left positions, thus the two pressing mechanisms 76 press the transfer unit 28 against the photoreceptor unit 26. As the pressing mechanisms 76 press the transfer unit 28 against the photoreceptor unit 26, the conveyance belt 60 and the photoreceptors 40 are in an excellent contact state (see FIG. 1). The details of the pressing mechanism 76 will be described later.

A groove 80 used as an engagement member is formed in the cover 13. The groove 80 is formed with space surrounded by a surface 82 formed on the apparatus inner side of the cover 13 and a surface 84 opposing the surface 82, and has a width slightly wider than an outer diameter of the projection 74. Accordingly, the projection 74 is movable in the groove 80. The surface 84 is a surface opposite to the surface 82, of a projection 88, formed to project toward a central portion of the image forming apparatus 10 in parallel with the surface 82, from a projection 86 projecting toward the apparatus inner side from the cover 13.

The projection 74 is inserted in the groove 80, and the groove 80 and the projection 74 engage with each other. Accordingly, the cover 13 and the transfer unit 28 engage with each other, and the transfer unit 28 moves in accordance with movement of the cover 13.

A limiting plate 90, used as a limiting section, and used as a limiting member, is attached to the surface 82 by e.g. attachment using an adhesive or the like. The details of the limiting plate 90 will be described later. Note that the groove 80, the surface 82, the surface 84, the projection 86, the projection 88 and the limiting plate 90 are respectively provided on both right and left sides of the image forming apparatus 10.

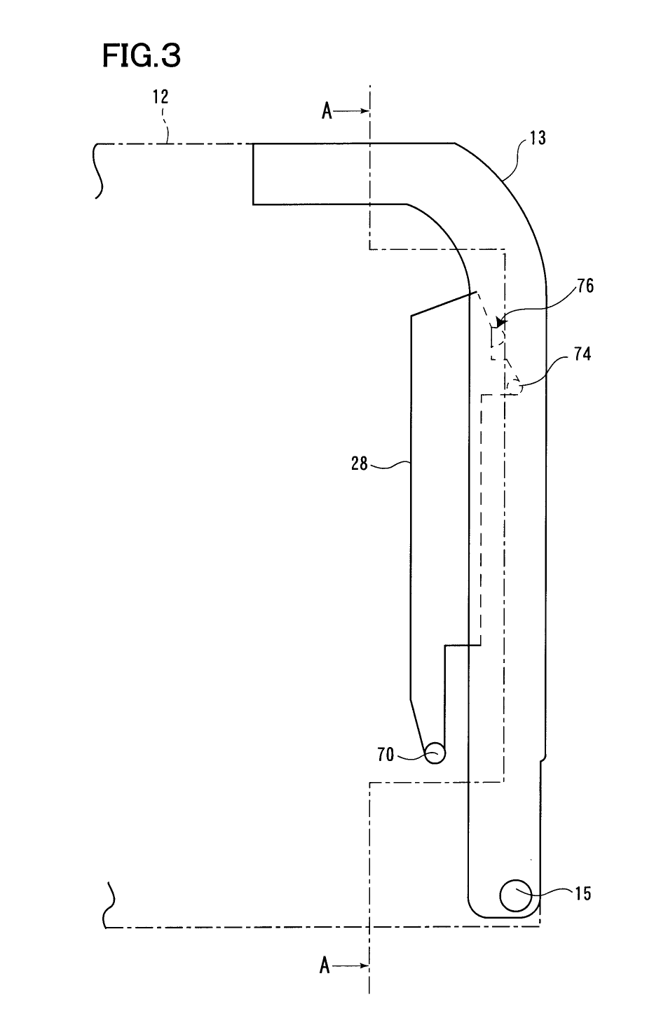

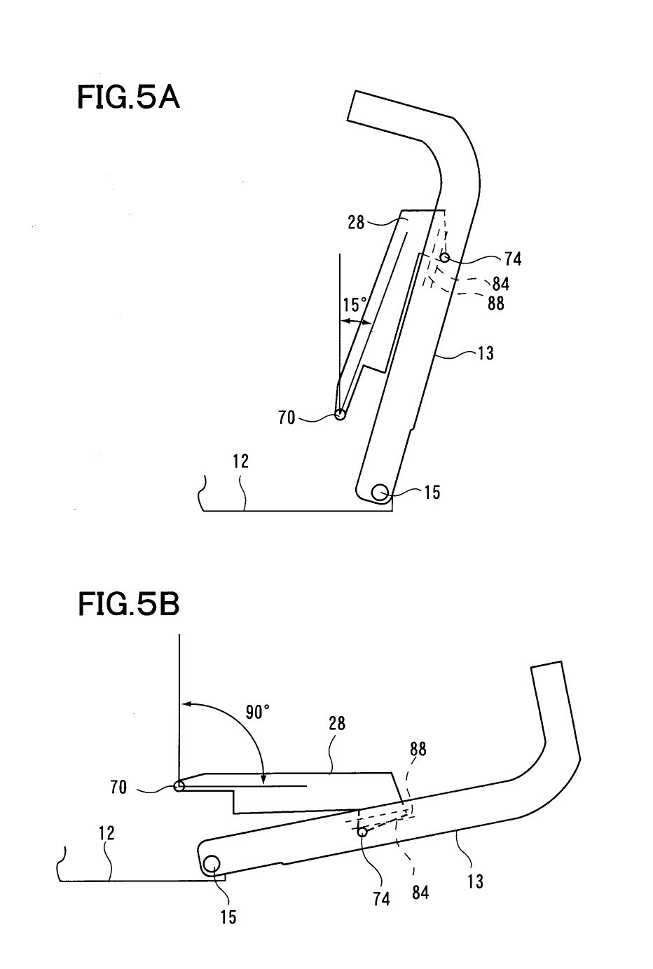

FIGS. 5A and 5B show movement of the cover 13 and the transfer unit 28 with respect to the image forming apparatus main body 12. In the image forming apparatus 10 having the above structure, when the cover 13, in a closed state (see FIG. 3), is opened by an operator, the cover 13 starts rotation about the shaft 15. Then, when the cover 13 is opened at a predetermined angle, the surface 84 of the projection 88 comes into contact with the projection 74. From this state, when the cover 13 is further opened, the projection 74 is pressed with the surface 84, and the transfer unit 28 starts rotational movement about the shaft 70. After the start of rotation of the transfer unit 28, the projection 74, being guided with the groove 80, moves from the entrance side of the groove 80 toward the back side.

FIG. 5A shows a state where the transfer unit 28 has rotated by 15 degrees from a state where the transfer unit 28 is used for image formation (see FIG. 3). FIG. 5B shows a state where the transfer unit 28 has rotated by 90 degrees from the state where the transfer unit 28 is used for image formation.

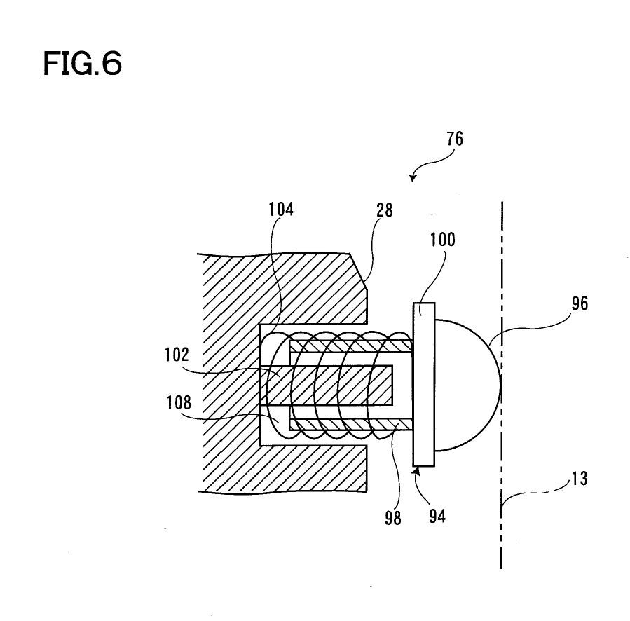

FIG. 6 shows the details of the above-described pressing mechanism 76. The pressing mechanism 76 has a moving member 94. The moving member 94 has a contact part 96, a cylindrical part 98, and a coupling part 100 to couple the contact part 96 with the cylindrical part 98. The contact part 96, having e.g. an approximately semispherical shape, comes into contact with the cover 13 and is pressed with the cover 13. The cylindrical part 98 is formed in a cylindrical shape, in which one side opposite to the contact part 96 is opened. A projection 102 is inserted into the cylindrical part 98, thereby the moving member 94 is set in the transfer unit 28. One end of a spring 108 formed of an elastic body, which is used as a pressing member, is fixed to a surface on the cylindrical part 98 side of the coupling part 100.

The projection 102 is provided in a concave part 104 formed in the main body of the transfer unit 28, and used as a guide member to guide movement of the moving member 94. A bottom portion of the concave part 104 is used as a second pressing part, and fixed to an end of the spring 108 opposite to the end fixed to the moving member 94. Accordingly, the moving member 94 is coupled with the transfer unit 28 with the spring 108.

When the transfer unit 28 is in the state where it is used for image formation (see FIG. 2), the contact part 96 of the moving member 94 is pressed with the cover 13 to the left side in FIG. 6. When the moving member 94 is pressed to the left side, the spring 108 is pressed with the moving member 94 to the left side. As the spring 108 is pressed to the left side, the transfer unit 28 is pressed against the photoreceptor unit 26.

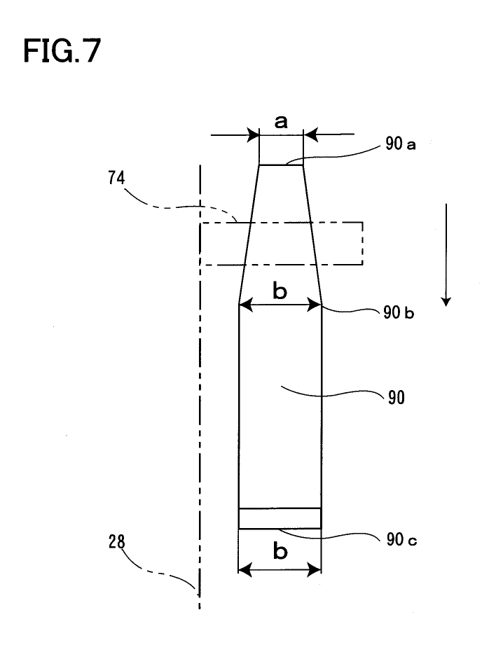

FIG. 7 shows the limiting plate 90. The limiting plate 90 is formed of a material having a dynamic coefficient of friction higher than that of the surface 82 of the cover 13. In the limiting plate 90, one end 90a has a width a, and the width is linearly increased toward a position 90b. The width in the position 90b is b. The width from the position 90b to the other end 90c is the same b.

The limiting plate 90 is attached to the surface 82 of the cover 13 such that the end 90a side is positioned on the upper side (see FIGS. 2 and 4). Accordingly, when the operator moves the transfer unit 28 with respect to the image forming apparatus main body 12 and thereby the projection 74 starts movement in the groove 80, then the projection 74 starts to come into contact with the end 90a of the limiting plate 90 when the transfer unit 28 has rotated by a predetermined angle. Then, when the transfer unit 28 is further rotated, the projection 74, in contact with the limiting plate 90, moves downward on the surface of the limiting plate 90, passing through the position 90b, to the other end 90c side.

In the first exemplary embodiment, the attachment position of the limiting plate 90 is determined such that, in the state where the transfer unit 28 has rotated by 15 degrees from the position in which it is used for image formation (hereinbelow, referred to as an “initial position”) (see FIG. 5A), the projection 74 arrives at the end 90a, and the projection 74 starts to come into contact with the limiting plate 90. Then, in the state where the transfer unit 28 has rotated by 45 degrees from the initial position, the projection 74 arrives at the position 90b. Thereafter, when the transfer unit 28 has moved to the position 90 degrees from the initial position, the projection 74 arrives at the other end 90c.

When the cover 13 and the transfer unit 28 have started movement and before the transfer unit 28 arrives from the initial position to the 15 degree angle position, the moving speed of the cover 13 and the transfer unit 28 is not limited with the limiting plate 90. When the transfer unit 28 has rotated by 15 degrees from the initial position, since the projection 74 comes into contact with the limiting plate 90 having a dynamic coefficient of friction higher than that of the surface 82, the projection 74 receives a higher friction force in the groove 80. That is, after rotation of the transfer unit 28 by 15 degrees, the moving speed of the transfer unit 28 and the cover 13 is reduced. Accordingly, the impact and damage applied to the movable portions such as the shaft 15, a portion of the cover 13 supported with the shaft 15, the shaft 70 and a portion of the transfer unit 28 supported with the shaft 70, are reduced.

In accordance with the rotation of the transfer unit 28 from the 15 degree angle position to the 45 degree angle position, the projection 74, in contact with the limiting plate 90, moves from the end 90a to the position 90b. At this time, as the width of the limiting plate 90 is gradually increased, the area of contact between the projection 74 and the limiting plate 90 is gradually increased, and the projection 74 receives a higher friction force from the limiting plate 90.

In this manner, in connection with the movement of the cover 13 and the transfer unit 28, the limiting plate 90 limits the moving speed of the cover 13 and the transfer unit 28 by control of the friction force applied to the cover 13 and the transfer unit 28. That is, in connection with the rotation of the transfer unit 28 to the 15 degree angle position, the friction force applied to the transfer unit 28 and the cover 13 is increased, thereby limitation of the speed of the transfer unit 28 and the cover 13 is started. That is, in connection of the rotation of the transfer unit 28 to the 45 degree angle position, the friction force applied to the transfer unit 28 and the cover 13 is gradually increased, thereby the speed of the transfer unit 28 and the cover 13 is gradually reduced.

As the material of the limiting plate 90, foamed polyurethane as a foamed material in an approximately closed-cell foaming state is used. Note that the foamed material contains air bubbles in the material. By use of the foamed material, the limiting plate 90 can be appropriately deformed, and can excellently absorb the impact upon contact with the projection 74. Further, the approximately closed-cell foaming state means that the bubbles in the material are not connected but approximately independent of each other. As the foamed material in the approximately closed-cell foaming state is used as the material of the limiting plate 90, the air bubbles are not easily deformed even by repeated pressing from the projection 74, and the deformation and wear-out of the limiting plate 90 do not easily occur.

As the material of the limiting plate 90, the foamed polyurethane may be replaced with foamed polystyrene, foamed polyethylene, foamed elastomer, foamed silicone, foamed synthetic rubber or the like. Note that since the projection 74 moves while it is in contact with the surface of the limiting plate 90, the limiting plate 90 may have a double lay structure with an abrasion-resistant surface layer.

Further, the density of the foamed polyurethane used as the material of the limiting plate 90 is approximately 480 Kg/m³. This value is obtained by measurement in conformity with JISK6401. The density of the foamed polyurethane used as the material of the limiting plate 90 may be 240 Kg/m³ or higher and 500 Kg/m³ or lower. When foamed polyurethane having a density of 240 Kg/m³ or higher is used, there is a probability that the projection 74 excessively digs into the limiting plate 90. In such case, the moving speed of the cover 13 and the transfer unit 28 may become too slow, or wear-out may easily occur in the limiting plate 90. On the other hand, when the density is 500 Kg/m³, there is a probability that the impact upon contact with the projection 74 can not be sufficiently absorbed. From the view point of excellent control of the operations of the cover 13 and the transfer unit 28, the view point of prevention of wear-out of the limiting plate 90, and the view point of excellent impact absorption, a material particularly having a density of 320 Kg/m³ or higher and 500 Kg/m³ or lower may be used. In the present exemplary embodiment, as described above, the foamed polyurethane having a density of approximately 480 Kg/m³ is used as the material of the limiting plate 90.

In the first exemplary embodiment, the limiting plate 90 is provided on the groove 80 side, however, it may be arranged such that a member to control the friction force applied to the groove 80 and the projection 74 is provided in at least one of the groove 80 and the projection 74. Further, it may be arranged such that a member to limit the friction force applied to the groove 80 and the projection 74 is provided in the projection 74 instead of providing the limiting plate 90 on the surface 82 of the groove 80 or in addition to providing the limiting plate 90 on the surface 82.

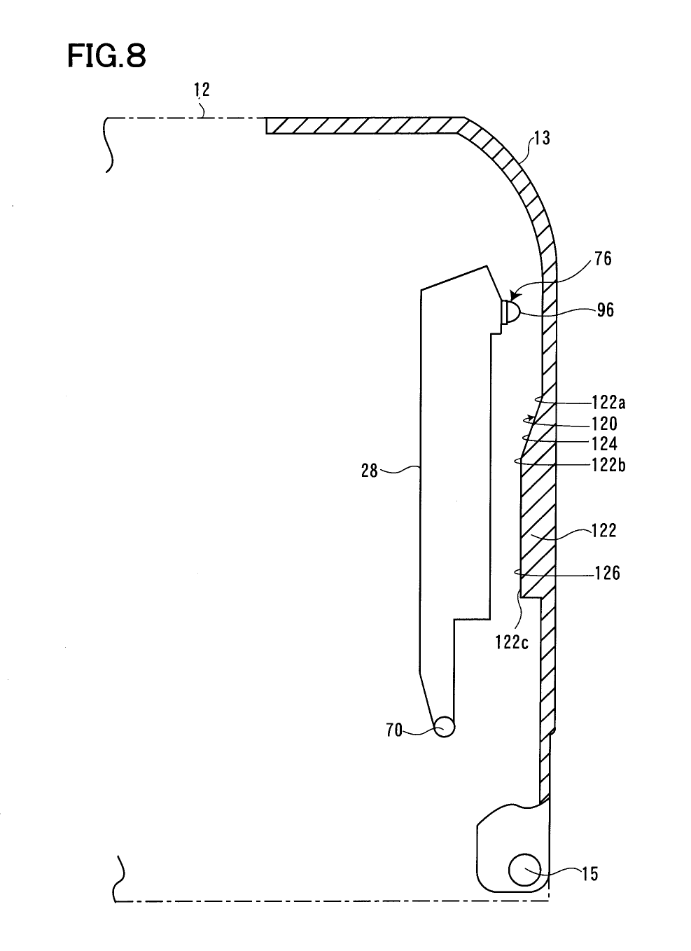

FIG. 8 shows the transfer unit 28 and the cover 13 of the image forming apparatus 10 according to a second exemplary embodiment of the present invention. In comparison with the above-described first exemplary embodiment, in the first exemplary embodiment, the area of contact between the limiting plate 90 and the projection 74 is controlled thereby the moving speed of the cover 13 and the transfer unit 28 is limited. On the other hand, in the second exemplary embodiment, the pressing mechanism 76, and a pressing force control mechanism 120 to control a pressing force of the cover 13 to press the contact part 96 used as a limiting member, are used as the limiting section, so as to limit the moving speed of the cover 13 and the transfer unit 28.

The pressing force control mechanism 120 has a convex part 122 provided on the apparatus inner side of the cover 13. The convex part 122 has a shape which rises from an upper end 122a and gradually becomes higher to a position 122b, and forms a slope 124 used as a first pressing part between the upper end 122a and the position 122b. Further, the convex part 122 forms a surface 126, which has a fixed height between the position 122b and a lower end 122c and which is used as the first pressing part similar to the slope 124, between the position 122b and the lower end 122c. As in the case of the pressing mechanism 76, the pressing force control mechanism 120 is provided on the both right and left sides of the image forming apparatus 10. The explanations of constituent elements identical to those in the first exemplary embodiment will be omitted.

In the second exemplary embodiment having the above structure, when the cover 13 is opened by the operator, the cover 13 starts rotation about the shaft 15. Then, when the cover 13 is opened to a predetermined angle, the contact part 96 of the pressing mechanism 76 comes into contact with the upper end 122a side of the convex part 122, and the contact part 96 is pressed with the slope 124 to the transfer unit 28 side. Then, when the contact part 96 is pressed, the transfer unit 28 is pressed with the spring 108 (see FIG. 6) in a direction to move away from the cover 13. The projection 74 of the transfer unit 28 and the projection 88 provided on the cover 13 come into press-contact with each other, thereby the moving speed of the cover 13 and the transfer unit 28 is limited.

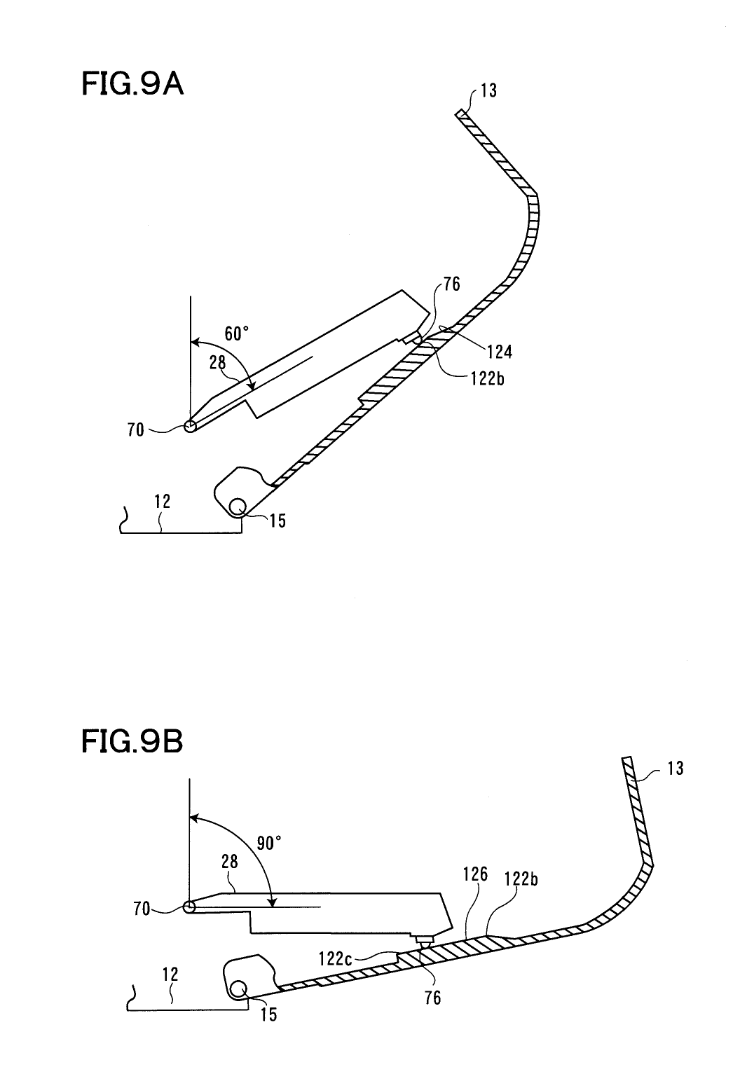

When the cover 13 is further opened, the contact part 96 moves, while sliding on the slope 124, toward the position 122b. As shown in FIG. 9A, when the transfer unit 28 moves from the initial position to a 60-degree-angle-rotated position, the contact part 96 arrives at the position 122b. While the cover 13 moves to the 60-degree-angle-position, the contact part 96 is gradually pressed with the slope 124 to a position closer to the transfer unit 28, accordingly, the distance between the slope 124 used as the first pressing part and a bottom of the concave part 104 used as a second pressing part (see FIG. 6) gradually becomes shorter, and the pressing force of the projection 74 and the projection 88 by elasticity of the spring 108 gradually becomes larger. As the pressing force of the projection 74 and the projection 88 gradually becomes larger, the moving speed of the cover 13 and the transfer unit 28 is controlled to gradually become slower.

When the cover 13 is further opened, the contact part 96 moves, while sliding on the surface 126, toward the lower end 122c of the convex part 122. FIG. 9B shows a state in which the transfer unit 28 has moved from the initial position to a 90-degree-angle-rotated position. While the transfer unit 28 moves from the position shown in FIG. 9A to the position shown in FIG. 9B, since the height of the convex part 122 is fixed, a predetermined pressing force is applied to the cover 13 and the transfer unit 28.

In the above-described second exemplary embodiment, the limiting plate 90 provided in the first exemplary embodiment is not provided. However, the limiting plate 90 may be provided in the above-described second exemplary embodiment. In this case, it may be arranged such that the limiting plate 90 and the pressing force control mechanism 120 are used so as to limit the moving speed of the cover 13 and the transfer unit 28.

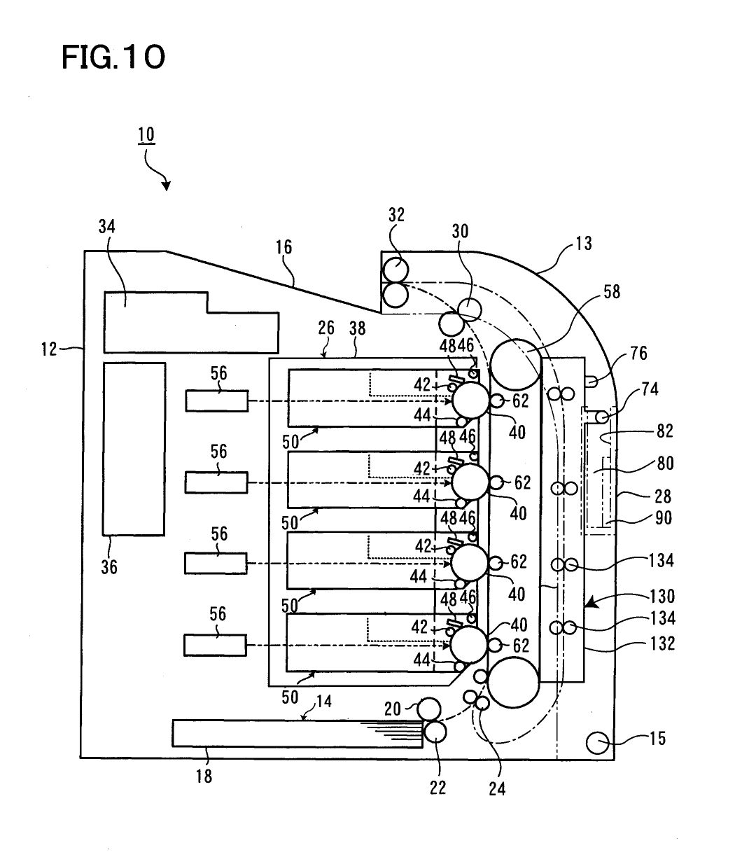

FIG. 10 shows the image forming apparatus 10 according to a third exemplary embodiment of the present invention. In the first and second exemplary embodiments, the image forming apparatus 10 has the limiting plate 90 or the pressing force control mechanism 120 to limit the moving speed of the cover 13 and the transfer unit 28. On the other hand, in the third exemplary embodiment, the image forming apparatus 10 has a reverse unit 130 to reverse a sheet, and the limiting plate 90 limits the moving speed of the reverse unit 130 and the cover 13.

The reverse unit 130 has a reverse unit main body 132, in which conveyance rollers 134 are provided. A sheet, on one surface of which image formation has been performed, supplied by reverse rotation of the sheet discharge roller 32, is conveyed, while reversed, with the conveyance rollers 134, to the registration roller 24 again. By use of the reverse unit 130, image formation can be performed on both sides of the sheet.

As in the case of the transfer unit 28 in the first example, the reverse unit main body 132 is provided with the projection 74. Further, as in the case of the cover 13 in the first exemplary embodiment, the groove 80 is formed in the cover 13, and the limiting plate 90 is attached to the surface 82 forming the groove 80. As in the case of the first exemplary embodiment, as the projection 74 comes into contact with the limiting plate 90, the moving speed of the cover 13 and the reverse unit 130 is limited. Note that in FIG. 10, the constituent elements identical to those in the first exemplary embodiment have the same reference numerals and the explanations thereof will be omitted.

In the above-described third exemplary embodiment, the moving speed of the cover 13 and the reverse unit 130 is limited by use of the limiting plate 90 as in the case of the first exemplary embodiment. However, the limiting plate 90 may be replaced with the pressing force control mechanism 120 as in the case of the second exemplary embodiment, or the pressing force control mechanism 120 may be added to the structure of the third exemplary embodiment, so as to limit the moving speed of the cover 13 and the transfer unit 28 with the pressing force control mechanism 120.

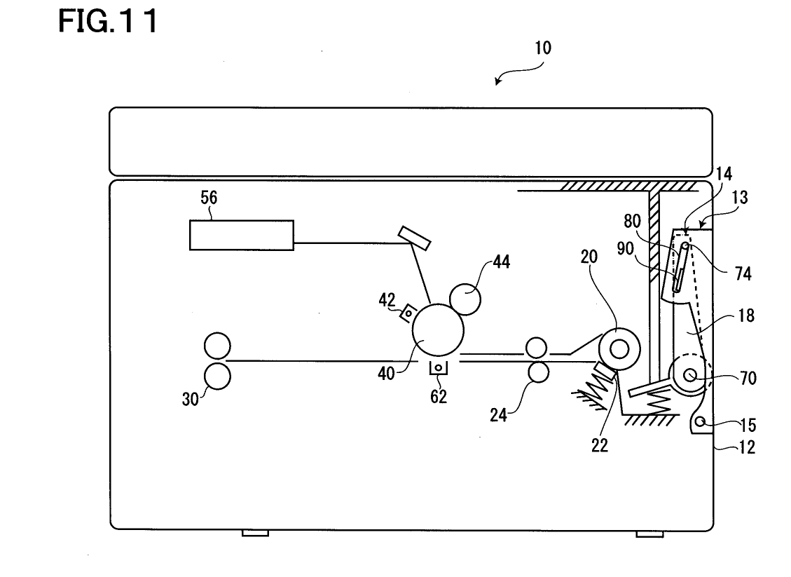

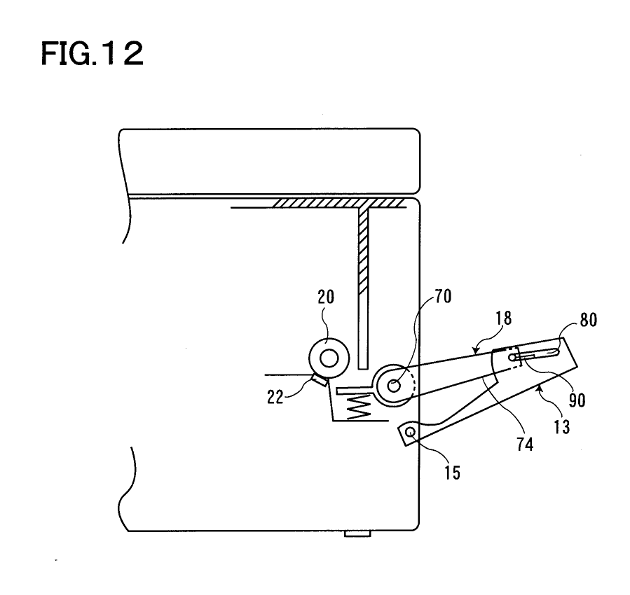

FIGS. 11 and 12 show the image forming apparatus 10 according to a fourth exemplary embodiment of the present invention. The image forming apparatus 10 has the image forming apparatus main body 12, and the sheet feeding device 14 is provided in a side part of the image forming apparatus main body 12. Further, the image forming apparatus main body 12 includes the photoreceptor 40, the charging device 42 to uniformly charge the photoreceptor 40, the optical writing device 56 to perform optical writing on the photoreceptor 40 charged with the charging device 42, the developing device 44 to develop a latent image written with the optical writing device 56, a transfer device 62 to transfer a developing material image formed with the developing device 44 to a sheet, and the fixing device 30 to fix the developing material image, transferred to the sheet with the transfer device 62, to the sheet.

The sheet feeding device 14 used as a unit has the sheet tray 18 used as a second member, on which a large number of sheets are stacked. The sheet tray 18 is provided rotatably with respect to the image forming apparatus main body 12 with the shaft 70. The sheet tray 18 moves between a position inside the image forming apparatus main body 12 shown in FIG. 11 and a use position shown in FIG. 12.

The feed roller 20 is provided on the left side of the sheet tray 18 in FIG. 11, and a retard pad 22 is provided in a position opposite to the feed roller 20. A top sheet on the sheet tray 18 is picked up with the feed roller 20, and the sheet is retarded and conveyed by cooperation between the feed roller 20 and the retard pad 22. The registration roller 24 is provided downstream of the feed roller 20 in the sheet conveyance direction.

The image forming apparatus main body 12 is provided with the cover 13 as a first member, used as an open-close cover. The cover 13 is attached rotatably (movably) to the image forming apparatus main body 12 with the shaft 15 used as a supporting section.

In the first exemplary embodiment, the image forming apparatus 10 has the limiting plate 90 to limit the moving speed of the cover 13 and the transfer unit 28. On the other hand, in the fourth exemplary embodiment, the limiting plate 90 is used for limiting the moving speed of the sheet tray 18 and the cover 13. That is, as in the case of the first exemplary embodiment, the groove 80 is formed in the cover 13. Further, the limiting plate 90 is attached to the surface forming the groove 80.

As in the case of the transfer unit 28 in the first exemplary embodiment, the sheet tray 18 is provided with the projection 74. As the projection 74 is inserted into the groove 80 and the projection 74 comes into contact with the limiting plate 90, the moving speed of the cover 13 and the sheet tray 18 is limited.

In the above-described fourth exemplary embodiment, the moving speed of the cover 13 and the sheet tray 18 is limited by use of the limiting plate 90 as in the case of the first exemplary embodiment. However, the limiting plate 90 may be replaced with the pressing force control mechanism 120 as in the case of the second exemplary embodiment, or the pressing force control mechanism 120 may be added to the structure of the third exemplary embodiment, so as to limit the moving speed of the cover 13 and the sheet tray 18 with the pressing force control mechanism 120. Note that the explanations of the constituent elements identical to those in the first exemplary embodiment will be omitted.

As described above, the present invention is applicable to an image forming apparatus having a unit provided movably with respect to an image forming apparatus main body such as a transfer unit. Further, the present invention is applicable to, not only the image forming apparatus, but an open-close apparatus having an apparatus main body and a member provided movably with respect to the apparatus main body.

The foregoing description of the exemplary embodiments of the present invention has been provided for the purposes of illustration and description. It is not intended to be exhaustive or to limit the invention to the precise forms disclosed. Obviously, many modifications and variations will be apparent to practitioners skilled in the art. The embodiments were chosen and described in order to best explain the principles of the invention and its practical applications, thereby enabling others skilled in the art to understand the invention for various embodiments and with the various modifications as are suited to the particular use contemplated. It is intended that the scope of the invention be defined by the following claims and their equivalents.

What is claimed is:

1. An open-close apparatus comprising:
a first member movably provided with respect to an apparatus main body;
a second member movable with respect to the first member, and movably provided with respect to the apparatus main body; and
a limiting section, provided between the first and second members, that limits a moving speed of the first and second members.

2. The open-close apparatus according to claim 1, wherein the first and second members move about different supporting points with respect to the apparatus main body.

3. The open-close apparatus according to claim 1, wherein when the first and second members have moved by a predetermined or larger amount, the limiting section limits the moving speed of the first and second members.

4. The open-close apparatus according to claim 1, wherein when the amount of movement of the first and second members is smaller than a predetermined amount, the limiting section releases limitation of the moving speed of the first and second members.

5. The open-close apparatus according to claim 1, when the first and second members have moved by a predetermined or more amount, the limiting section limits the moving speed of the first and second members, while when the amount of movement of the first and second members is smaller than the predetermined amount, the limiting section releases limitation of the moving speed of the first and second members.

6. An open-close apparatus comprising:
a first member movably provided with respect to an apparatus main body;
a second member movable with respect to the first member and movably provided with respect to the apparatus main body, that comes into contact with the first member; and
a limiting member provided in a position in which the first and second members come into contact, that limits a moving speed of the first and second members.

7. The open-close apparatus according to claim 6, wherein the first and second members rotate about different supporting points with respect to the apparatus main body.

8. The open-close apparatus according to claim 6, wherein the limiting member limits the moving speed of the first and second members by a friction force.

9. The open-close apparatus according to claim 8, wherein the limiting member limits the moving speed of the first and second member by different friction forces in correspondence with movement of the first and second members.

10. The open-close apparatus according to claim 6, wherein the limiting member is pressed by a pressing section against the first or second member, thereby limits the moving speed of the first and second members.

11. The open-close apparatus according to claim 10, wherein the limiting member is pressed against the first or second member with a pressing force which differs in correspondence with movement of the first and second members.

12. An image forming apparatus comprising:
an image forming apparatus main body containing an image forming section and a sheet conveyance section;
an open-close cover movably provided with respect to the image forming apparatus main body;
a unit movable with respect to the open-close cover, constructing at least a part of the image forming section or the sheet conveyance section, movably provided with respect to the image forming apparatus main body; and
a limiting section provided between the unit and the open-close cover, that limits a moving speed of the unit and the open-close cover.

13. An image forming apparatus comprising:
an image forming apparatus main body containing an image forming section and a sheet conveyance section;
an open-close cover movably provided with respect to the image forming apparatus main body;
a unit movable with respect to the open-close cover, movably provided with respect to the image forming apparatus main body, that comes into contact with the open-close cover, constructing at least a part of the image forming section or the sheet conveyance section; and
a limiting member provided in a position in which the open-close cover and the unit come into contact, that limits a moving speed of the open-close cover and the unit.
